(19) United States
(12) Patent Application Publication
(10) Pub. No.: US 2016/0162128 A1
(43) Pub. Date: Jun. 9, 2016

(54) SYSTEM AND METHOD FOR CONFIGURING ACTION BUTTONS DISPLAYED IN A GUI

(71) Applicant: salesforce.com, inc., San Francisco, CA (US)

(72) Inventors: Nick Hansen, Arvada, CO (US); Kevin Sean Cripps, Boulder, CO (US); Michael Dwayne Miller, Boulder, CO (US); Peter Norman Hale, Arvada, CO (US); Kathryn C. Bierbaum, Boulder, CO (US)

(73) Assignee: salesforce.com, inc., San Francisco, CA (US)

(21) Appl. No.: 14/753,255

(22) Filed: Jun. 29, 2015

Related U.S. Application Data
(60) Provisional application No. 62/088,922, filed on Dec. 8, 2014.

(51) Int. Cl. G06F 3/0482; H04L 29/08; G06F 3/0484

(52) U.S. Cl. CPC G06F 3/0482; G06F 3/04842; H04L 67/02

(57) ABSTRACT

Computer-implemented systems and methods are provided for configuring action buttons of a particular page that is displayed at a graphical user interface (GUI) of a particular client device of a particular tenant. In one embodiment, a console computer of a particular tenant is in communication with a server of an application provider. Based on a context that is specified by that particular tenant for that particular page, the console computer can be used to define a subset of relevant action buttons to be displayed at the GUI for the particular page, and an arrangement that orders the subset of relevant action buttons. The particular page can then be displayed at the GUI of the particular client device such that it includes the subset of relevant action buttons that have been arranged according to the arrangement.

### CROSS-REFERENCE TO RELATED APPLICATION

This application claims the benefit of U.S. provisional patent application Ser. No. 62/088,922, filed Dec. 8, 2014, which is hereby incorporated by reference in its entirety.

### TECHNICAL FIELD

Embodiments of the subject matter described herein relate generally to graphical user interfaces. More particularly, embodiments of the subject matter relate to features, methodologies, and functions for use in configuring the display of action buttons in a GUI.

### BACKGROUND

Designing a graphical user interface (GUI) for navigating within a display poses many challenges. Presently known navigational paradigms present the user with icons or virtual “action” buttons which, when selected, transition the GUI to new view to facilitate a more or less detailed level of interaction. As more buttons are presented at various contextual levels and at various locations within the two-dimensional viewing space, the GUI may become cluttered.

Companies that provide enterprise cloud computing platforms and services can be referred to herein as cloud-hosted application service provider, or simply as an application provider for sake of brevity. Such application providers host applications that are generic and can be used by different “tenants” (e.g., businesses or “customer organizations”) to meet their business needs. The tenants share the applications in a secure way so that they can adapt them for their own use. These applications can display pages via desktop GUIs or mobile GUIs.

Designing a GUI for a mobile device is particularly challenging due to the limited viewing area (“real estate”) that is available in a hand held display. When a page is displayed on a screen of a mobile device only a limited number of action buttons can be displayed. The application provider that provides the application defines which action buttons will be displayed for each particular page. The specific selection and arrangement of the action buttons in each page is static or fixed by the application provider. For each page, only certain, specific action buttons are displayed at specific locations. For instance, the action buttons may be grouped according to their “action type” and displayed together at a particular location in each page. Thus, for each page, the same generic action buttons are presented.

One drawback of this approach is that each tenant is presented with the same set of action buttons arranged in the same way. However, different tenants, and even different users within the same tenant, have different needs and preferences regarding which action buttons are displayed on a given page. This can result in an inconvenient user experience, and negatively impact the users productivity.

Accordingly, it is desirable to provide systems and methods that allow for the selection and arrangement of action buttons displayed in each page to be specified and changed based on the requirements of each tenant. It would also be desirable if the action buttons displayed at each page can be tailored for each user or client device so that the user can quickly see the action buttons that are important to that user. Furthermore, other desirable features and characteristics will become apparent from the subsequent detailed description and the appended claims, taken in conjunction with the accompanying drawings and the foregoing technical field and background.

### SUMMARY

Computer-implemented systems and methods are provided for configuring action buttons of a particular page that is displayed at a graphical user interface (GUI) of a particular client device of a particular tenant. In one embodiment, a console computer of a particular tenant is in communication with a server of an application provider. Based on a context that is specified by that particular tenant for the particular page, the console computer can be used to define a subset of relevant action buttons to be displayed at the GUI for the particular page, and an arrangement that orders the subset of relevant action buttons. The particular page can then be displayed at the GUI of the particular client device such that it includes the subset of relevant action buttons that have been arranged according to the arrangement.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of a system in accordance with an exemplary embodiment;

FIG. 2 is a schematic representation of an exemplary embodiment of an apparatus suitable for use in the system of FIG. 1;

FIG. 3 is a flow chart that illustrates an exemplary embodiment of process for configuring action buttons in a graphical user interface (GUI) of a client device;

FIG. 4 is a screenshot of a conventional display screen of a mobile wireless communication device that illustrates conventional configuration of action buttons;

FIG. 5 is a screenshot of a display screen of a mobile wireless communication device according to one non-limiting exemplary implementation of the disclosed embodiments; and

FIG. 6 is a screenshot of a display screen of the mobile wireless communication device when a user selects the publisher action button of FIG. 5 to trigger display of an action menu according to one non-limiting exemplary implementation of the disclosed embodiments.

### DETAILED DESCRIPTION

The following detailed description is merely exemplary in nature and is not intended to limit the disclosure the application and uses of the disclosure. Furthermore, there is no intention to be bound by any expressed or implied theory presented in the preceding technical field, background, brief summary or the following detailed description. It should be understood that throughout the drawings, corresponding reference numerals indicate like or corresponding parts and features.

The exemplary embodiments presented here relate to a system and related techniques, methodologies, procedures, and technology for configuring action buttons in a GUI. As can be appreciated, the described subject matter can be implemented in the context of various environments. For exemplary purposes, the subject matter is described in the context of a computer-implemented environment relating to, for example, software products for a software-based system, a server system, a multi-tenant environment that is used to provide a service to a plurality of different tenants (or organizations), a plurality of different end users, and/or a plurality of different tenant applications, or the like. Moreover, the described subject matter can be implemented in connection with two or more separate and distinct computer-implemented systems that cooperate and communicate with one another.

Computer-implemented systems and methods are provided for configuring action buttons of a particular page that is displayed at a graphical user interface (GUI) of a particular client device of a particular tenant. In one embodiment, a console computer of a particular tenant is in communication with a server of an application provider. Based on a context that is specified by that particular tenant for that particular page, the console computer can be used to define a subset of relevant action buttons to be displayed at the GUI for the particular page, and an arrangement that orders the subset of relevant action buttons. The particular page can then be displayed at the GUI of the particular client device such that it includes the subset of relevant action buttons that have been arranged according to the arrangement.

In accordance with an embodiment, an application programming interface (API) is provided for use in configuring the selection and arrangement of the action buttons that are displayed within a GUI application. In one exemplary use case, the API allows an organization level administrator to specify which action buttons are displayed (and in what order) at an end client device logged into the organization's portal. Specifically, the API allow the administrator to: i) filter out selected action buttons that are to be displayed to particular users or user groups based on, for example, group affiliation and/or permission level; ii) determine the order, priority, or ranking in which the selected action buttons are either displayed or hidden; and iii) merge or consolidate the buttons into a single, integrated action bar.

Prior to describing the drawings, definitions of certain terminology used throughout the description will now be provided.

Action

As used herein, the term “action” refers to logic that allows a user to perform a task or work. Each action serves a unique purpose and has a corresponding action button or link that invokes that action.

Categories and Types of Actions

There are different types or categories of actions. Some examples of the different types or categories of actions can include: object-specific actions (OSAs) that are explicitly tied to an object and are created in the context of the object (e.g., OSAs operate within the context of an object); global actions that enable users to create object records and operate with user context, but operate without object context; standard actions defined by the application provider; custom actions that are defined by the application provider and can be edited by the tenant to customize them or that can be defined by the tenant; default actions; mobile smart actions; custom actions that have functionality defined by a tenant to create unique actions that are specific to their business and that can be used to launch custom pages created by the tenant; and productivity actions defined by the application provider that can appear on a set of objects such as account, contact, event, lead, user, user profile, etc. For example, to illustrate one specific, non-limiting example of the difference between an OSA and a global action, an OSA can use a current object/record as context, for example, to create a contact that is tied to an account being viewed. By contrast, global actions are performed without such context (e.g., creating a contact which is not associated with anything, posting a question to a message board, etc.). Neither type necessarily needs to result in the creation or modification of a record, such as actions which navigate to a web page.

Action Button

An action button is a user interface element or component that can be selected by a user when a user interacts with it (e.g., selects or otherwise activates it) to invoke, trigger or execute a specific action. Action buttons can be predefined and provided by the application provider, or edited or uniquely created by an administrator of a tenant (or customer organization).

Page

A page refers to a particular instance that is displayed via a GUI on a display screen of a computer display. Types of pages can include account pages, case pages, contact pages, custom pages, event pages, feed pages, group pages, lead pages, list view pages, opportunity pages, people pages, person account pages, related list pages, search results pages, task pages, etc. Each page can include various action buttons.

Overview

In conventional applications, each page is configured to display specific actions buttons. Within a page layout, the action buttons are grouped according to a type or category at fixed locations within that page. Within that grouping, the order or arrangement of the action buttons can vary, but only within that fixed location.

In accordance with the disclosed embodiments, within a particular page, the action buttons that are displayed, and the order and arrangement of those action buttons, can be set by an administrator of a tenant based on context that is defined or specified by that particular tenant, regardless of category or type of action and the recommended settings or configuration that is specified by the application provider for that tenant.

In one embodiment, the server obtains context data for the particular client device, and analyzes the context data to determine the context being requested. The context being requested can be specified for the particular page by that particular tenant. The context can include information that specifies the particular page, an identifier that identifies the particular client device of the particular tenant, an identifier that identifies a particular user of the particular client device of the particular tenant, an identifier that identifies a particular user group affiliation of the particular client device of the particular tenant, an identifier that identifies a particular user group affiliation of the particular user of the particular tenant, and/or a permission level associated with a particular user of the particular client device of the particular tenant.

The server can then evaluate factories to retrieve relevant action buttons for the context being requested. Each factory can generate, in response to the context, particular objects that correspond to the relevant action buttons. Based on filtering information for the context being requested, the relevant action buttons from each factory can be filtered to identify the subset of relevant action buttons to be displayed at the GUI for the context being requested. Based on sorting information for the context being requested, the subset of the relevant action buttons can be sorted to determine an order in which the subset of relevant action buttons are to be displayed at the GUI so that the arrangement of the sorted relevant action buttons is customized for context being requested. When all factories have been evaluated, the server can generate instructions for configuring the subset of relevant action buttons within the particular page and communicate the instructions to the particular client device. The instructions can include instructions regarding how each of the subset of relevant action buttons are to be arranged when displayed at the GUI of the particular client device. In one embodiment, the subset of relevant action buttons can be displayed within an action bar at the GUI. This subset of relevant action buttons can be customized by the tenant regardless of recommended action buttons that are specified by the application provider for that particular page

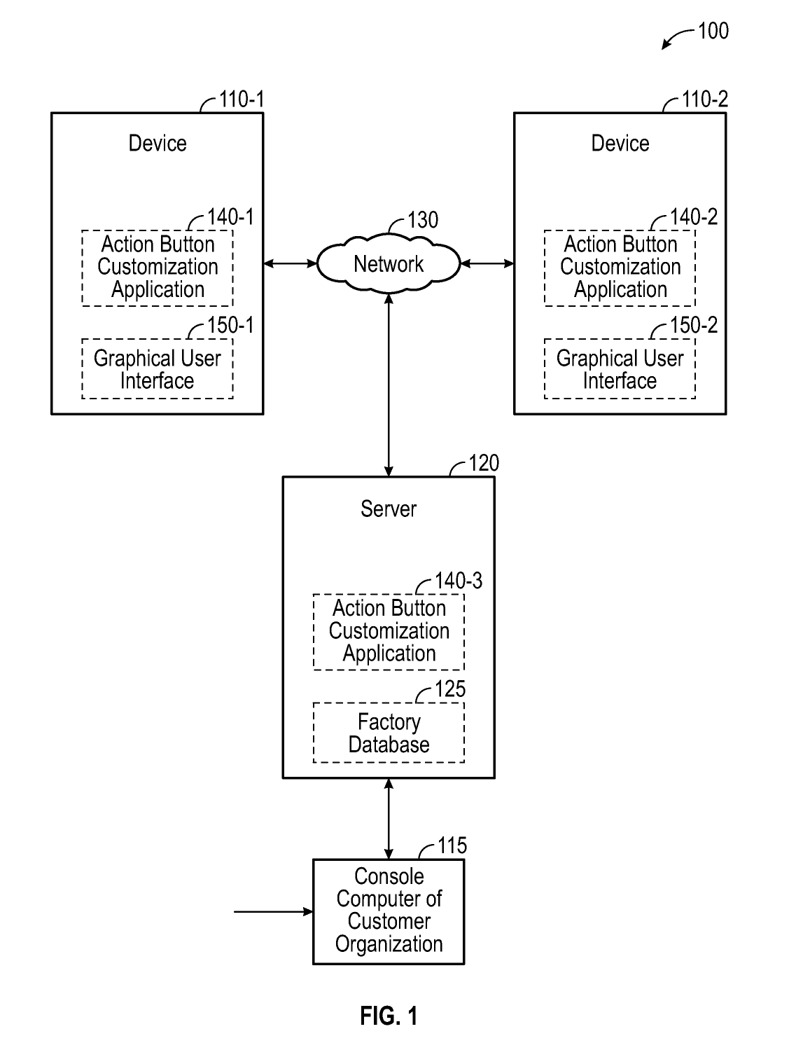

Referring now to the drawings, FIG. 1 is a schematic representation of an exemplary embodiment of a system 100 that can be used to implement the disclosed embodiments. The system 100 presented in FIG. 1 represents only one possible embodiment of the system 100, which leverages techniques for configuring action buttons in a GUI. The illustrated embodiment of the system 100 includes a first client device 110-1, a second client device 110-2, a server 120 of an application provider that is operatively coupled to the client devices 110 through a data communication network 130, and a console computer 115 that allows an administrator of a tenant to access the server 120 of the application provider. The system 100 is preferably realized as a computer-implemented system in that the client devices 110-1, 110-2, console computer 115, and the server 120 are configured as computer-based electronic devices.

Although only two client devices 110-1, 110-2 are shown in FIG. 1, an embodiment of the system 100 could support any number of client devices. Each client device supported by the system 100 may be implemented using any suitable hardware platform. In this regard, a client device may be realized in any common form factor including, without limitation: a desktop computer; a mobile computer (e.g., a tablet computer, a laptop computer, or a netbook computer); a smartphone; a video game device; a digital media player; a piece of home entertainment equipment; or the like. Each client device supported by the system 100 is realized as a computer-implemented or computer-based device having the hardware, software, firmware, and/or processing logic needed to carry out the techniques and methodologies described in more detail herein.

The console computer 115 is associated with a tenant (e.g., particular business or customer organization).

The server 120 is associated with an application provider that provides applications to various tenants. As used herein, the term “application provider” refers to an entity that provides enterprise cloud computing platforms and services to multiple tenants. As such, the term “application provider” can refer to a cloud-hosted application service provider. The server 120 can be, for example, part of a hosted database system that supports various tenants. The server 120 can be deployed in certain embodiments of the system 100 to manage, handle, and/or serve some or all of the functionality used to configure action buttons of the graphical user interfaces (GUI) of the client devices. In practice, the server 120 may be realized as a computer-implemented or computer-based system having the hardware, software, firmware, and/or processing logic needed to carry out the techniques and methodologies described in more detail herein.

The server 125 can include a factory database 125 that stores various factories. As used herein, a “factory” refers to a module (e.g., software that executes at a processor) to generate, in response to context data that specifies a particular context, particular objects that correspond to different action buttons that may be relevant for that particular context. To explain further, each factory corresponds to a set of action types, and for a particular context specified by particular context data, a particular factory will create particular objects that correspond to different action buttons that may be relevant for that particular context. As such, a factory can be used to abstract construction of the particular objects such that the caller does not need to understand how to create those particular objects. Thus, the factories can be used to retrieve relevant action buttons (for the context being requested).

The system 100 includes an action button customization application 140, which may be realized at the server 120 only, or distributed across any of the client devices 110-1, 110-2, the console computer 115 and the server 120. The action button customization application 140 is responsible for configuring action buttons of the graphical user interfaces (GUI) of the client devices 110-1, 110-2 of the system 100. To this end, the client devices 110-1, 110-2 may include or cooperate with the action button customization application 140, which provides the features and functionality associated with configuring action buttons of the graphical user interfaces (GUI) of the client devices 110-1, 110-2.

The data communication network 130 provides and supports data connectivity between the client devices 110-1, 110-2 and the server 120. In practice, the data communication network 130 may be any digital or other communications network capable of transmitting messages or data between devices, systems, or components. In certain embodiments, the data communication network 130 includes a packet switched network that facilitates packet-based data communication, addressing, and data routing. The packet switched network could be, for example, a wide area network, the Internet, or the like. In various embodiments, the data communication network 130 includes any number of public or private data connections, links or network connections supporting any number of communications protocols. The data communication network 130 may include the Internet, for example, or any other network based upon TCP/IP or other conventional protocols. In various embodiments, the data communication network 130 could also incorporate a wireless and/or wired telephone network, such as a cellular communications network for communicating with mobile phones, personal digital assistants, and/or the like. The data communication network 130 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

As will be described in greater detail below, in one embodiment, the console computer 115 communicates information to the server 120 to define, based on a context that is specified by that particular tenant for a particular page, a subset of relevant action buttons selected based the context and an arrangement that orders the subset of relevant action buttons. A particular client device 110 of the particular tenant can receive this information from the server 120 when rendering the particular page at a graphical user interface 150 of the client device 110 such that the particular page includes the subset of relevant action buttons that have been selected and arranged according to the arrangement.

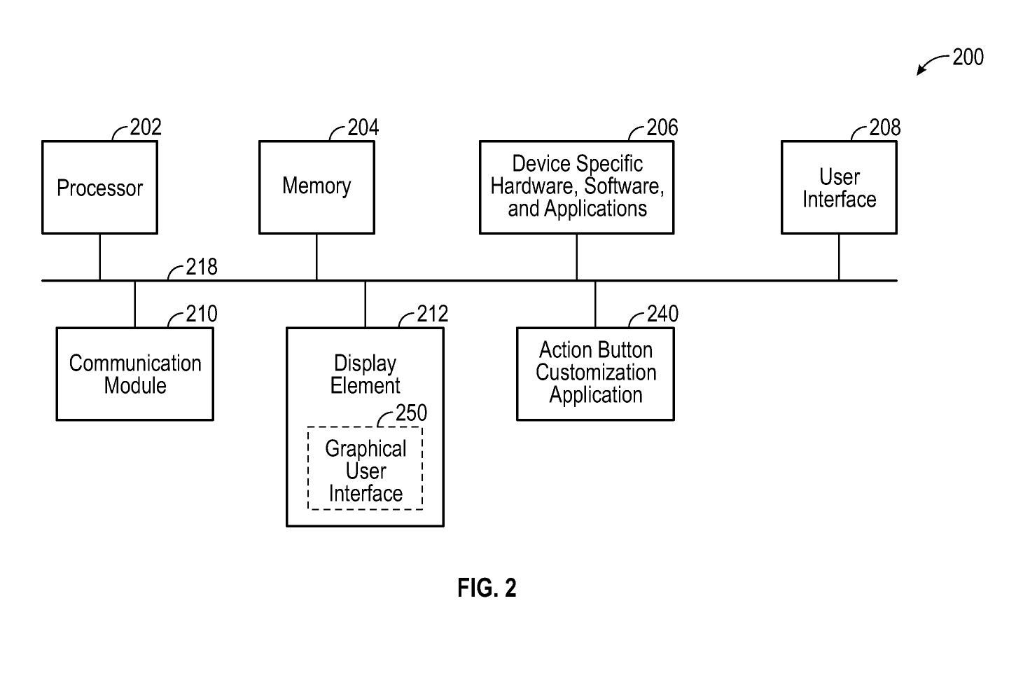

FIG. 2 is a schematic representation of an exemplary embodiment of an apparatus, system, or device 200 suitable for use in the system of FIG. 1. In practice, the client devices 110-1, 110-2 and the server 120 could be generally configured and implemented as shown in FIG. 2. Thus, the following general description of the device 200 may be applicable to the client device 110-1, the client device 110-2, the console computer 115 and/or the server 120.

The illustrated embodiment of the device 200 includes, without limitation: at least one processor 202; a suitable amount of memory 204; device-specific hardware, software, firmware, and/or applications 206; a user interface 208; a communication module 210; a display element 212 that includes a GUI 250; and an action button customization application 240. The device 200 may include additional elements, components, modules, and functionality configured to support various features that are unrelated to the subject matter described here. For example, the device 200 may include certain features and elements to support conventional functions that might be related to the particular implementation and deployment of the device 200. In practice, the elements of the device 200 may be coupled together via a bus or any suitable interconnection architecture 218.

The processor 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. A processor may be realized as a microprocessor, a controller, a microcontroller, or a state machine. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

The memory 204 may be realized as RAM memory, flash memory, EPROM memory, EEPROM memory, registers, a hard disk, a removable disk, a CD-ROM, or any other form of storage medium known in the art. In this regard, the memory 204 can be coupled to the processor 202 such that the processor 202 can read information from, and write information to, the memory 204. In the alternative, the memory 204 may be integral to the processor 202. As an example, the processor 202 and the memory 204 may reside in an ASIC. The memory 204 can be used to store computer-readable media, where a tangible computer-readable medium has computer-executable instructions stored thereon. The computer-executable instructions, when read and executed by the device 200, cause the device 200 to perform certain tasks, operations, functions, and processes described in more detail herein. In this regard, the memory 204 may represent one suitable implementation of such computer-readable media. Alternatively or additionally, the device 200 could receive and cooperate with computer-readable media (not separately shown) that is realized as a portable or mobile component or platform, e.g., a portable hard drive, a USB flash drive, an optical disc, or the like.

The device-specific hardware, software, firmware, and applications 206 may vary from one embodiment of the device 200 to another. For example, the device-specific hardware, software, firmware, and applications 206 will support telephone functions and features when the device 200 is realized as a mobile telephone, conventional personal computer functions and features if the device 200 is realized as a desktop or portable computer, and server functions and features if the device 200 is realized as a server. In practice, certain portions or aspects of the device-specific hardware, software, firmware, and applications 206 may be implemented in one or more of the other blocks depicted in FIG. 2.

The user interface 208 may include or cooperate with various features to allow a user to interact with the device 200. Accordingly, the user interface 208 may include various human-to-machine interfaces, e.g., a keypad, keys, a keyboard, buttons, switches, knobs, a touchpad, a joystick, a pointing device, a virtual writing tablet, a touch screen, a microphone, or any device, component, or function that enables the user to select options, input information, or otherwise control the operation of the device 200. In this regard, it is noted that the display element 212 and GUI 250 can be part of the user interface 208 in some embodiments even though FIG. 2 depicts them as distinct elements for ease of illustration.

The communication module 210 facilitates data communication between the device 200 and other components as needed during the operation of the device 200. In the context of this description, the communication module 210 can be employed during a messaging session that includes the device 200 as one of the participant devices. An embodiment of the device 200 may support wireless data communication and/or wired data communication, using various data communication protocols. For example, the communication module could support one or more wireless data communication protocols, techniques, or methodologies, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; wireless hospital or health care facility network protocols such as those operating in the WMTS bands; GPRS; and proprietary wireless data communication protocols such as variants of Wireless USB. Moreover, the communication module could support one or more wired/cabled data communication protocols, including, without limitation: Ethernet; home network communication protocols; USB; IEEE 1394 (Firewire); hospital network communication protocols; and proprietary data communication protocols.

The display element 212 is suitably configured to enable the device 200 to render and display various graphical user interfaces (GUIs) 250, screens, drop down menus, auto-fill fields, text entry fields, message fields, action buttons or the like. The display element 212 may also be utilized for the display of other information during the operation of the device 200. Notably, the specific configuration, operating characteristics, size, resolution, and functionality of the display element 212 can vary depending upon the practical implementation of the device 200. For example, if the device 200 is a desktop computer, then the display element 212 may be a relatively large monitor. Alternatively, if the device 200 is a cellular telephone device, then the display element 212 may be a relatively small integrated display screen, which may be realized as a touch screen.

The action button customization application 240 represents the hardware, software, firmware, and/or processing logic that supports the various features and functions described here. As noted above, the action button customization application 240 is responsible for configuring action buttons of the graphical user interfaces (GUI) of the client devices 110-1, 110-2 of the system 100. As shown in FIG. 1, the action button customization application 240 can be implemented at the server 120 and the client devices 110. However, it should be appreciated that the action button customization application 240 need not be implemented in each and every device in the system 100. In one embodiment, the action button customization application 240 can include specific modules of processor executable code that are executed by a processing circuit implemented at the server 120 to generate instructions that are used to configure action buttons in a GUI of a client device 110.

In one embodiment, the action button customization application 240 can be computer program product that is stored in a non-transitory computer readable medium having a computer readable program code embodied therein. The computer readable program code is readable by a processing circuit and stores instructions for execution by the processing circuit to perform a method for configuring action buttons of a particular page that is to be displayed at a GUI of a particular client device of a particular tenant. In general, based on a context that is specified by the particular tenant for the particular page, a subset of relevant action buttons can be specified that are specific to the context as well as an arrangement that orders the subset of relevant action buttons to be displayed at the GUI for the particular page. Display instructions can then be generated and communicated to the particular client device 110 of the particular tenant. The display instructions indicate the subset of relevant action buttons that have been selected to be displayed at the GUI for the particular page, and the arrangement of the subset of relevant action buttons within the particular page.

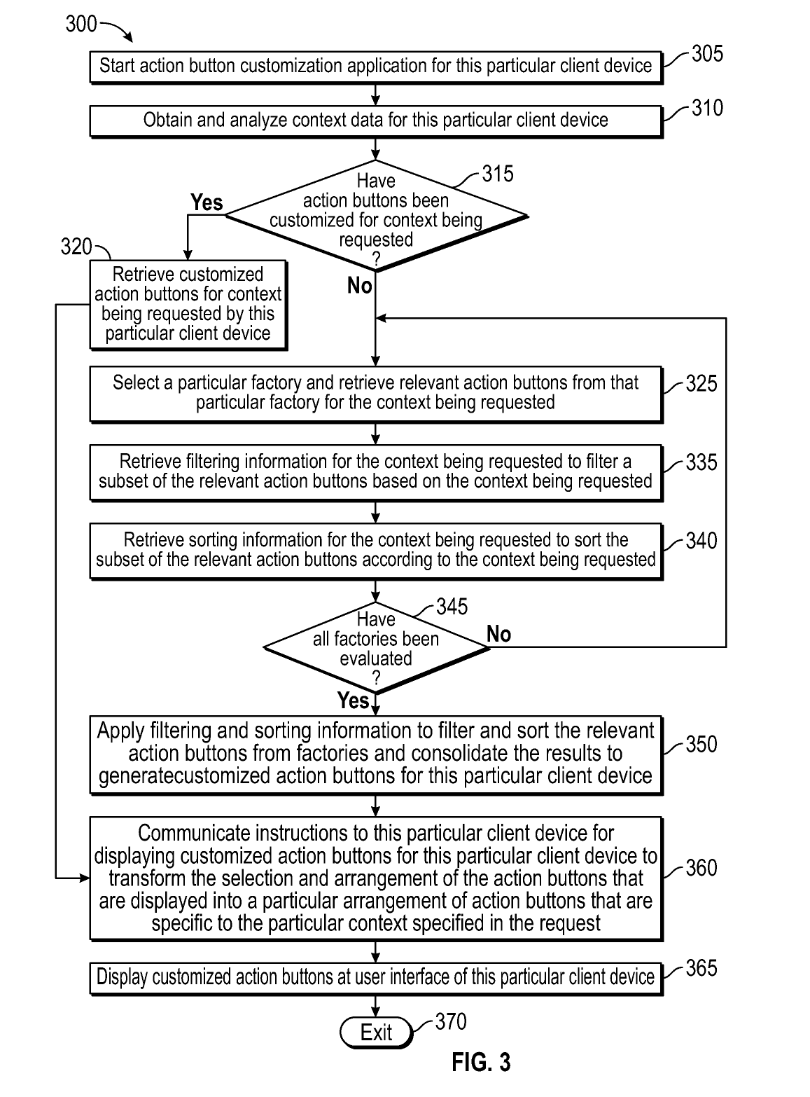

FIG. 3 is a flow chart that illustrates an exemplary embodiment of process 300 for configuring action buttons in a GUI of a client device.

The process 300 may be carried out by a client device and a server such as that depicted in FIG. 1. Accordingly, the process 300 may be realized as a computer-implemented method of configuring action buttons in a GUI. The various tasks performed in connection with the process 300 may be performed by software, hardware, firmware, or any combination thereof. For illustrative purposes, the following description of the process 300 may refer to elements mentioned above in connection with FIG. 1 and FIG. 2. As such, FIG. 3 will be described with reference to FIGS. 1 and 2. In practice, portions of the process 300 may be performed by different elements of the described system, e.g., a client device, a server, or a component or element thereof. For example, while certain steps of process 300 will be described as being performed by the server 120, it will be appreciated that in one embodiment a processing circuit or processor at the server 120 executes the action button customization application 140-3 to perform most of these steps. It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The process 300 begins at 305 when the action button customization application for this particular client device 110 is activated. The activation at 305 can be triggered by any number of different events. For instance, when a user of a particular client device 110 navigates to a screen (or page) that has actions associated with it, this can trigger activation of the action button customization application. In one embodiment, the particular client device 110 can communicate a request message to the server 120 to activate the action button customization application.

At 310, the server 120 obtains context data from the particular client device 110 and analyzes that context data for that particular client device 110. In general, the context data is information that is used to select what action buttons are visible to a particular user for a page/screen being viewed. The context data can include information such as: information that identifies the client device 110, information that identifies the user of the client device 110, information that specifies a permission level for the client device 110 or for the user or the client device 110, information that specifies a group affiliation for the client device 110 or for the user or the client device 110, information that specifies which particular page, record or object the user is viewing, etc.

At 315, the server 120 determines whether “relevant” action buttons have been customized for context being requested. In one embodiment, after 325-350 are performed the first time, the action buttons have been customized for the context being requested by this particular client device, and therefore the decision at 315 will be “yes.” In other words, after the action buttons have been customized via 325-350, these steps are no longer necessary (unless the administrator updates the factories, filtering information, or sorting information), and the decision at 315 will be ‘yes” such that the process 300 proceeds to 320, and then to 360 through 370.

Thus, when the server 120 determines that relevant action buttons have been customized for context being requested, the process 300 proceeds to 320, where the server 120 retrieves customized action buttons for context being requested by this particular client device. The process 300 then proceeds to 360, where the server 120 communicates, to this particular client device 110, instructions for displaying customized action buttons for this particular client device. When the instructions are executed by the client device 110, this transforms the selection and arrangement of the action buttons that are displayed at the GUI of the client device 110 into a particular arrangement of action buttons that are specific to the particular context specified in the request. This can allow, for example, each page that is displayed at the GUI to be customized for each particular context (e.g., for each user or user group). The process 300 then proceeds to 365, where the customized action buttons that are specific to the particular context are displayed at GUI of this particular client device 110. The process 300 then ends at 370.

By contrast, when the server 120 determines (at 315) that action buttons have not been customized for context being requested, the process 300 proceeds to 325. At 325, the server 120 selects a particular factory from factory database 125, and retrieves relevant action buttons (for the context being requested) via that particular factory. The process 300 then proceeds to 335-345, where the server 120 filters and sorts the action buttons so that they are customized for context being requested.

At 335, the server 120 retrieves filtering information for the particular context being requested. The filtering information that is retrieved allows the server 120 to filter the action buttons to identify a subset of the relevant action buttons based on the particular context being requested. Stated differently, the filtering information that is retrieved is specific for the particular context being requested and can be used (at 350) to filter out a subset of the relevant action buttons that are relevant based on the particular context being requested. Depending on the implementation, the filtering information that is retrieved can depend on what state the process 300 is in.

For example, if the administrator has already customized certain filtering information, then that filtering information can be loaded from the database. By contrast, if the administrator has not already customized certain filtering information, then default information can be used.

In one embodiment, filtering information can be customized by displaying a prompt to an administrator (e.g., via an administrator console 115) that allows the administrator to define the filtering information. For instance, the administrator can specify a subset of the relevant action buttons based on the particular context being requested. As one example, the administrator can consider things such as a particular permission level for the context, and define filtering information for a particular permission level.

At 340, the server 120 retrieves sorting information for the particular context being requested. The sorting information that is retrieved allows the server 120 to sort (at 350) the subset of the relevant action buttons, according to the particular context being requested, to order the subset of relevant action buttons (e.g., to define the order in which the relevant action buttons will eventually be displayed).

For example, if the administrator has already customized certain sorting information, then that sorting information can be loaded from the database. By contrast, if the administrator has not already customized certain sorting information, then default sorting information can be used.

In one embodiment, a prompt can be displayed to an administrator (e.g., via an administrator console 115) that allows the administrator to define the sorting information. For instance, the administrator can specify the order and arrangement of the subset of the relevant action buttons for the particular context being requested. As one example, the administrator can define sorting information that specifies, based on the context, an order, priority or ranking for each of the relevant action buttons.

At 345, the server 120 determines whether all factories (for the context being requested) have been evaluated.

When the server 120 determines that all factories have not yet been evaluated, the process 300 loops back to 325, where the next factory is selected and relevant action buttons from that factory are retrieved. When the server 120 determines that all factories have been evaluated, the process 300 proceeds to 350. At 350, the server 120 applies filtering and sorting information to filter and sort the subset of relevant action buttons and consolidates the results to generate customized action buttons for the particular context being requested. These customized action buttons can then be used for other client devices that request this particular context.

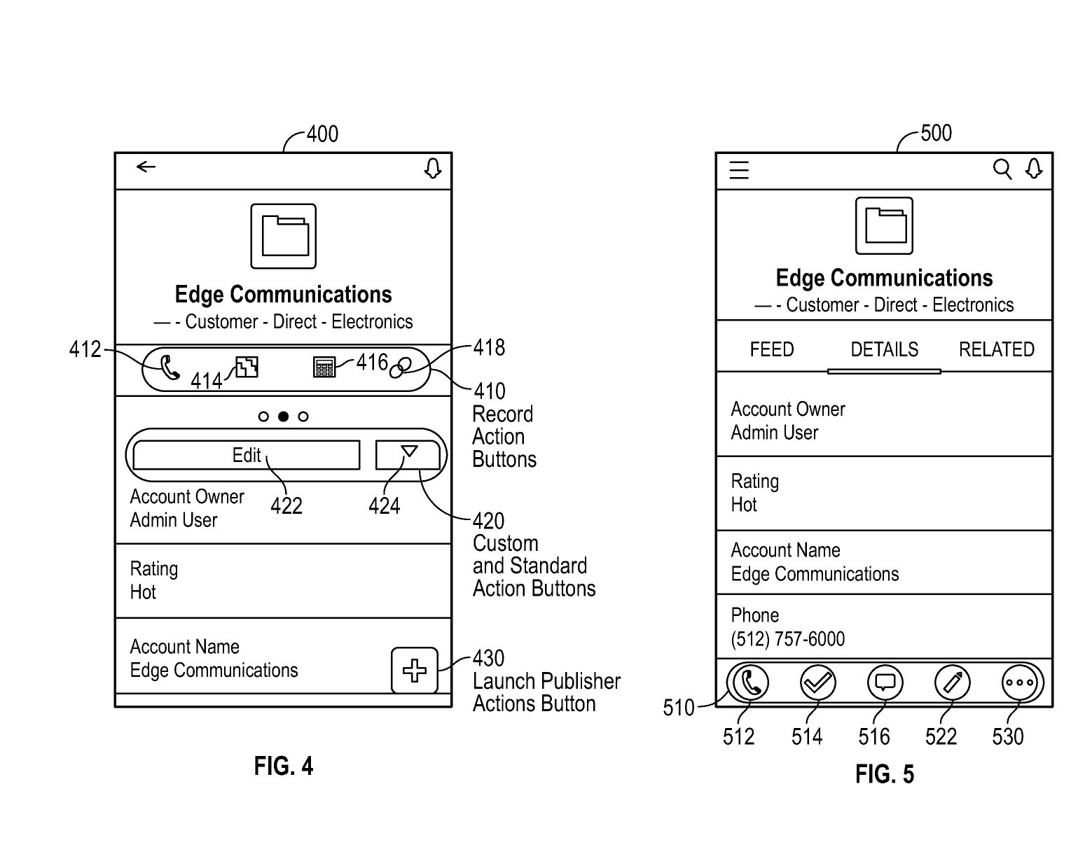

The process 300 then proceeds to 360. At 360, the server 120 communicates, to this particular client device 110, instructions for displaying customized action buttons for this particular client device. The instructions transform the selection and arrangement of the action buttons that are displayed at the GUI of the client device 110 into a particular arrangement of action buttons that are specific to the particular context specified in the request. At 365, customized set of action buttons that are specific to the particular context are displayed at GUI of this particular client device 110. This customized set of customized action buttons are a subset of action buttons that have been filtered and sorted. In one embodiment, the customized set of action buttons can be consolidated and displayed in a single action bar or action menu of the GUI of the client device 110. An example implementation of the action button customization application 140-3 will be described below with reference to FIGS. 4-6. The action buttons described below with reference to FIGS. 4-6 are exemplary and non-limiting.

FIG. 4 is a screenshot of a display screen 400 of a mobile wireless communication device that illustrates conventional configuration of action buttons displayed at the wireless communication device. In this non-limiting example, the GUI includes information such as an account name (i.e., “Edge Communications”), and fields for the Account Owner, (i.e., Admin User), Rating (i.e., Hot) and Account Name (i.e., Edge Communications). The GUI also includes various action buttons 412-418, 422, 424, 430 that are statically arranged and grouped according to action type. Action buttons that are commonly displayed via the GUI can be grouped together in different areas of the GUI. For example, one area 410 of the GUI can be used to display “record” action buttons, another area 420 of the GUI can be used to display “custom and standard” action buttons, another area 430 of the GUI can be used to display “publisher” action buttons, and another area (not illustrated in FIG. 4) of the GUI can be used to display “standard publisher” action buttons.

Record action buttons are a type of action button that typically performs some action natively on a client device. Examples of record action buttons can include, for example, a call action button 412, an e-mail action button 414, a map location action button 416, and a link action button 418 to the accounts website (e.g., an account website action button). Other record action buttons that are defined and provided by the application provider could also be displayed in the area 410 of the GUI that is reserved to display record action buttons.

Custom and standard action buttons are two different types of action buttons that are displayed in an area 420 of the GUI that is reserved to display custom and standard action buttons. Standard action buttons can include buttons that are defined and provided by the application provider, such as an edit action button 422 of FIG. 4. Other examples of standard action buttons can include, but are not limited to, a post action button, a file action button, a link action button and a poll-other-users action button, a new action button, a convert lead action button, a clone action button, and other action buttons that are defined and provided by the application provider). By contrast, custom action buttons 424 launch custom pages created by the tenant and may be defined and provided, for example, by an administrator of the tenant. Custom action buttons 424 allow the tenant to create unique actions that are specific to their business.

When the launch publisher actions button 430 is selected, a new page (not illustrated) can open and publisher action buttons (not illustrated in FIG. 4) can be displayed. Publisher action buttons (also known as quick action buttons) can include create action buttons that allow users to create records (e.g., create or update an object usually in relation to a record, where an object is any object that can be stored in the application provider's platform database). Publisher action buttons are associated with an Object such that inputs are the fields of an object. Publisher action buttons are often associated with an entity (e.g., account or contact). Examples of publisher action buttons can include a new task action button that allows a user to add a new task, a new contact action button that allows a user to add a new contact, a log-a-call action button that let users record details of phone calls or other customer interactions, an update action button that allows a user to make changes to a record, a question action button that enable users to ask and search for answers to questions about records that the user is working with, and other action buttons that are defined and provided by the application provider or created by the tenant).

Thus, in the GUI of the conventional display screen 400, only certain specific action buttons are displayed on a particular page. Moreover, those action buttons are arranged at specific locations, where the action buttons in each location are grouped according to their “action type.” In other words, record action buttons are displayed in a specific region marked by ellipse 410, custom and standard action buttons are displayed in a specific region marked by ellipse 420, and the publisher actions button 430 is displayed in a specific region marked by ellipse 430. The same GUI of the application provider is provided to each tenant. The tenant does not have the ability to select which action buttons are displayed, or the locations where those action buttons are displayed. Thus, the specific selection and arrangement of the action buttons in each ellipse 410-430 is static or fixed regardless of the needs of the tenant.

As described above, the process 300 allows for each tenant to customize and configure the selection and arrangement/order of action buttons that are displayed via the GUI on each particular page for each particular user. An example will now be described with reference to FIG. 5.

FIG. 5 is a screenshot of a display screen 500 of a mobile wireless communication device according to one non-limiting exemplary implementation of the disclosed embodiments. In this non-limiting example, the GUI includes information such as an account name (i.e., “Edge Communications”), and fields for the Account Owner, (i.e., Admin User), Rating (i.e., Hot), Account Name (i.e., Edge Communications) and Phone Number (i.e., (512) 757-6000). The GUI also includes a specific configuration of action buttons 512, 514, 516, 522, 530 in an action bar 510 after the disclosed embodiments have been applied. In accordance with the disclosed embodiments, the process 300 that is described with reference to FIG. 3 is used to configure the selection and arrangement of particular action buttons 512, 514, 516, 522, 530 that are displayed within the action bar 510 for each page (e.g., feed or record page that a user is viewing).

As illustrated in FIG. 5, within the action bar 510 there is a call log action button 512, a new task action button 514, a post action button 516, an edit action button 522, and a launch publisher actions button 530. As such, particular action buttons 512, 514, 516, 522, 530 that are displayed within the action bar 510 of this page can be configured as desired by the tenant such that different action “types” or “categories” are mixed together within the action bar 510 (e.g., included in the same container). From the feed, for example, a user may see a set of global actions. From a record page, however, the user may see a mix of productivity actions, standard and custom buttons, standard Chatter actions such as Post and File, and global and object-specific actions that are assigned to the layout for that record type.

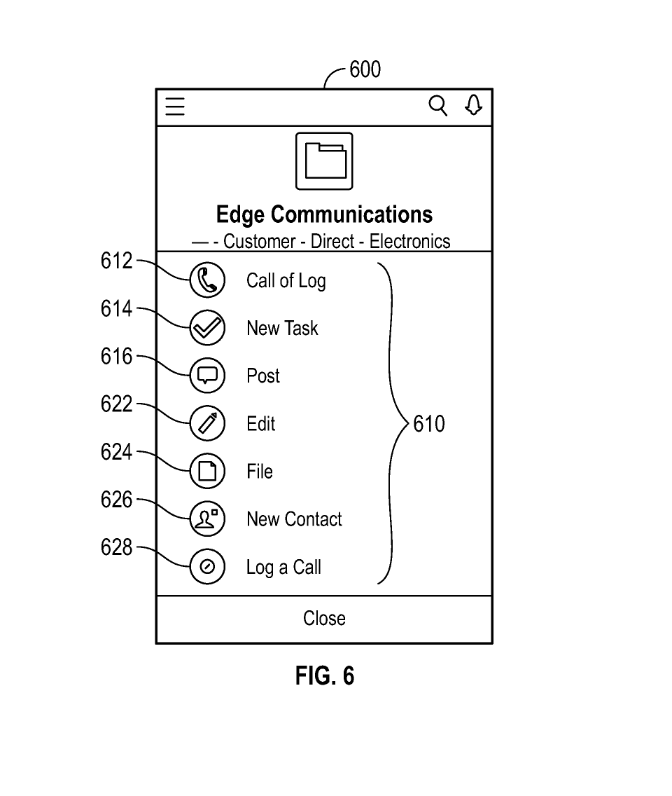

FIG. 6 is a screenshot of a display screen 600 of the mobile wireless communication device when a user selects the launch publisher actions button 530 of FIG. 5 to trigger display of a page that includes an action menu 610 according to one non-limiting exemplary implementation of the disclosed embodiments. For example, a user can select the launch publisher actions button 530 from the action bar 510 to open the action menu 610, which contains the full set of actions that are available for the object. In this particular example, the action menu 610 displayed in the GUI shows: a call log action button 612 (that is a type of productivity action), a new task action button 614 (that is a type of publisher action), a post action button 616 (that is a type of publisher action), an edit action button 622 (that is a type of standard action), a file action button 624 (that is a type of publisher action), a new contact action button 626 (that is a type of publisher action), and a log-a-call action button 628 (that is a type of publisher action). The action buttons displayed in the action menu 610 can be configured as desired by the by the tenant such that different action “types” or “categories” are mixed together within the action menu 610 (e.g., included in the same container).

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Any inventive concept, methodology, technique, process, or subject matter described herein may be implemented using any suitably configured processor-based, computer-based, or logic-based device, system, or architecture, and may be realized using one or more hardware components, devices, or platforms. In some embodiments, the operating environment may include a plurality of computing devices that communicate using a data communication network. In accordance with some embodiments, the operating environment may include or cooperate with a multi-tenant database system. A computing system that implements or executes the described processes, techniques, and methodologies may be embodied in various platforms including, without limitation: a personal computer; a server computer; a desk top application; a hand-held or laptop device; a tablet device; a smartphone or other type of mobile computing device; a digital media player device; an electronic medical device; a household appliance or product; a video game console or portable video game device; home entertainment equipment; a television component; a video services set-top box; a network architecture component (e.g., a switch, router, or repeater); a smart eyewear device; a smart watch or accessory device; and the like.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A computer-implemented method for configuring action buttons of a particular page that is displayed at a graphical user interface (GUI) of a particular client device of a particular tenant, the method comprising:
via a console computer of a particular tenant that is in communication with a server of an application provider: defining, based on a context that is specified by the particular tenant for that particular page, a subset of relevant action buttons to be displayed at the GUI for the particular page; and defining an arrangement that orders the subset of relevant action buttons based on the context; and
displaying the particular page at the GUI of the particular client device, wherein the particular page includes the subset of relevant action buttons that have been arranged according to the arrangement.

2. A method according to claim 1, further comprising:
obtaining, at the server, context data for the particular client device;
analyzing, at the server, the context data at the server to determine the context being requested, wherein the context being requested is specified for the particular page by that particular tenant; and
evaluating factories, at the server, to retrieve relevant action buttons for the context being requested, wherein each factory generates, in response to the context, particular objects that correspond to the relevant action buttons.

3. A method according to claim 1, wherein defining the subset of relevant action buttons, comprises:
from each factory: retrieving filtering information for the context being requested; and
filtering, based on the filtering information, the relevant action buttons from each factory to identify the subset of relevant action buttons to be displayed at the GUI for the context being requested.

4. A method according to claim 12, wherein defining the arrangement that orders the subset of relevant action buttons based on the context, comprises:
from each factory: retrieving sorting information for the context being requested; and
sorting the subset of the relevant action buttons, based on the sorting information, to determine an order in which the subset of relevant action buttons are to be displayed at the GUI so that the arrangement of the sorted relevant action buttons is customized for context being requested.

5. A method according to claim 1, further comprising:
generating, at the server when all factories have been evaluated, instructions for configuring the subset of relevant action buttons within the particular page, wherein the instructions comprise instructions regarding how the subset of relevant action buttons are to be arranged when displayed at the GUI of the particular client device; and
communicating the instructions from the server to the particular client device.

6. A method according to claim 1, wherein the context comprises:
information that specifies the particular page.

7. A method according to claim 6, wherein the context comprises:
an identifier that identifies the particular client device of the particular tenant.

8. A method according to claim 6, wherein the context comprises:
an identifier that identifies a particular user of the particular client device of the particular tenant.

9. A method according to claim 6, wherein the context comprises:
a permission level associated with a particular user of the particular client device of the particular tenant.

10. A method according to claim 6, wherein the context comprises:
an identifier that identifies a particular user group affiliation of the particular client device of the particular tenant.

11. A method according to claim 6, wherein the context comprises:
an identifier that identifies a particular user group affiliation of the particular user of the particular tenant.

12. A method according to claim 1, wherein the subset of relevant action buttons are displayed within an action bar at the GUI.

13. A method according to claim 12, wherein the subset of relevant action buttons that are displayed within the action bar are customized by the tenant regardless of recommended action buttons that are specified by the application provider for that particular page.

14. A method according to claim 1, wherein each action button is associated with either:
an object-specific action that operates within the context of an object, or
a global action that operates with user context and without object context.

15. A computer-implemented system, comprising:
a server of an application provider;
a console computer of a particular tenant that is in communication with a server, wherein the console computer communicates information to the server to define, based on a context that is specified by that particular tenant for a particular page, a subset of relevant action buttons selected based the context and an arrangement that orders the subset of relevant action buttons; and
a particular client device of the particular tenant, comprising: a display that displays the particular page at a graphical user interface (GUI), wherein the particular page includes the subset of relevant action buttons that have been selected and arranged according to the arrangement.

16. A computer-implemented system according to claim 15, wherein the server is configured to:
receive context data for the particular client device and analyze the context data to determine the context being requested, wherein the context being requested is specified by the particular tenant for the particular page; and
retrieve relevant action buttons for the context being requested from a plurality of factories, wherein each factory generates, in response to the context, particular objects that correspond to the relevant action buttons;
filter, based on filtering information for the context being requested, the relevant action buttons from each factory to identify the subset of relevant action buttons to be displayed at the GUI for the context being requested;
sort the subset of the relevant action buttons, based on the sorting information for the context being requested, to determine the order in which the subset of relevant action buttons are to be displayed at the GUI so that the arrangement of the sorted relevant action buttons is customized for context being requested;
generate instructions for configuring the subset of relevant action buttons within the particular page, wherein the instructions comprise instructions that specify the arrangement of the subset of relevant action buttons when displayed at the GUI of the particular client device; and
communicate the instructions to the particular client device.

17. A computer-implemented system according to claim 15, wherein the context comprises information that specifies the particular page and an identifier associated with the particular client device.

18. A computer-implemented system according to claim 17, wherein the identifier comprises at least one of:
an identifier that identifies the particular client device of the particular tenant;
an identifier that identifies a particular user of the particular client device of the particular tenant;
an identifier that identifies a particular user group affiliation of the particular client device of the particular tenant;
an identifier that identifies a particular user group affiliation of the particular user of the particular tenant.

15. A computer-implemented system according to claim 15, wherein the subset of relevant action buttons are displayed within an action bar at the GUI.

20. A computer program product, comprising:
a non-transitory computer readable medium having a computer readable program code embodied therein that is readable by a processing circuit and storing instructions for execution by the processing circuit to perform a method for configuring action buttons of a particular page that is to be displayed at a graphical user interface (GUI) of a particular client device of a particular tenant, the method comprising:
specifying, based on a context that is specified by the particular tenant for that particular page, a subset of relevant action buttons that are specific to the context and an arrangement that orders the subset of relevant action buttons to be displayed at the GUI for the particular page; and
generating display instructions for communication to the particular client device of the particular tenant, wherein the display instructions: indicate the subset of relevant action buttons that have been selected to be displayed at the GUI for the particular page, and the arrangement of the subset of relevant action buttons within the particular page.
